(19) United States
(12) Patent Application Publication
(10) Pub. No.: US 2007/0162740 A1
(43) Pub. Date: Jul. 12, 2007

(54) Systems, methods, and apparatus for packet level security

(76) Inventors: Sandeep Kumar Relan, Bangalore (IN); Naveen Kumar Syamala, Hyderabad (IN)

Correspondence Address: MCANDREWS HELD & MALLOY, LTD, 500 WEST MADISON STREET, SUITE 3400, CHICAGO, IL, 60661, US

(21) Appl. No.: 11/330,827

(22) Filed: Jan. 12, 2006

(51) Int. Cl. H04L 9/00

(52) U.S. Cl. 713/153

(57) ABSTRACT

Aspects of the present invention may be found in a system, method, and/or apparatus for packet level security. In embodiment, there is presented a network node for transmitting packets. The network node comprises at least one port, a random number generator, and a circuit. There is at least one port for receiving the packets. The random number generator generates random numbers. The random numbers are associated and vary with different times. The circuit applies particular ones of the random numbers to the packets. There is at least one port for transmitting the packets with the particular ones of the random numbers applied to the packets.

### RELATED APPLICATIONS

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Network security is becoming an increasingly important issue. Hackers and unauthorized users use a variety of techniques to gain unauthorized access to networks, intercept communications over the network, and/or disrupt the network. The techniques can target many different layers of the network.

The foregoing threats can be defended by using secure ports, secure protocols, providing security at forwarding levels, control security, and other means such as firewalls, virtual private network systems, content/port-80 firewalls, virus detection software enc-point security system, ACL based protection, layer 3 routers, and layer 2 switches. The foregoing takes the coordinated efforts of a large number of parties at many different layers. This is both costly, and does not guarantee that the efforts are fully sufficient for future variants of attacks.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Aspects of the present invention may be found in a system, method, and/or apparatus for packet security based on random token generation, substantially as shown in and/or described in connection with at least one of the figures, as set forth more completely in the claims.

These and other advantages and novel features of the present invention, as well as illustrated embodiments thereof will be more fully understood from the following description and drawings.

### BRIEF DESCRIPTION OF SEVERAL VIEWS OF THE DRAWINGS

FIG. 1 is a block diagram of an exemplary network node in accordance with an embodiment of the present invention;

FIG. 2 is a flow diagram for transmitting a packet in accordance with an embodiment of the present invention;

FIG. 3 is a block diagram of another network node in accordance with an embodiment of the present invention;

FIG. 4 is a flow diagram for validating a packet in accordance with an embodiment of the present invention;

FIG. 5 is a block diagram of an exemplary communication network in accordance with an embodiment of the present invention;

FIG. 6 is a flow diagram for transmitting packets in accordance with an embodiment of the present invention; and

FIG. 7 is a block diagram describing an exemplary hardware environment wherein the present invention can be practiced.

### DETAILED DESCRIPTION OF THE INVENTION

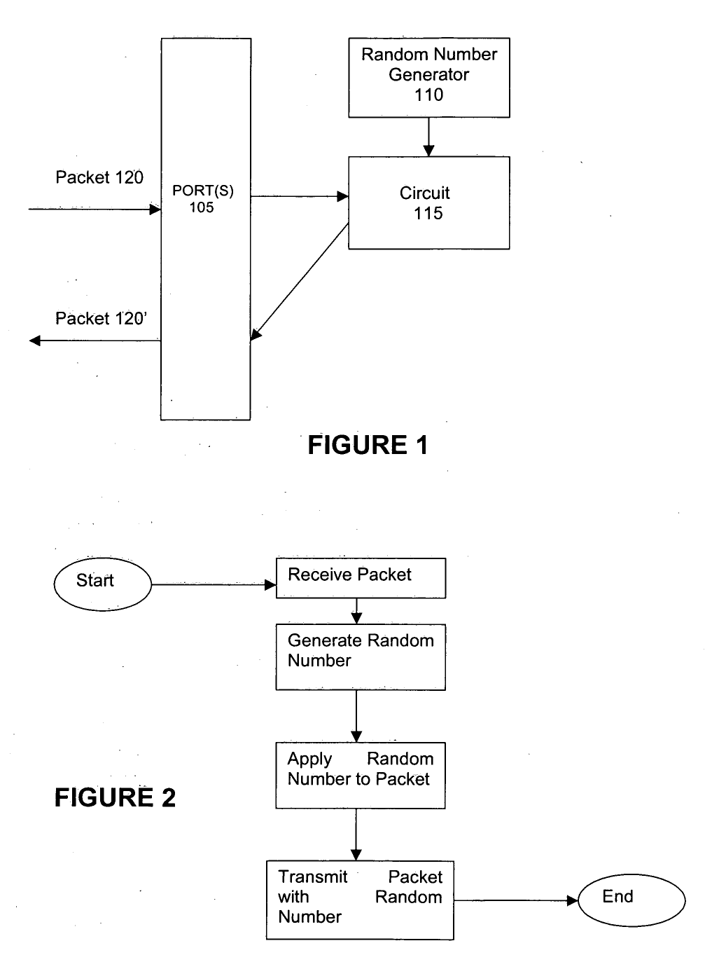

Referring now to FIG. 1, there is illustrated a block diagram of an exemplary network node 100 in accordance with an embodiment of the present invention. The network node comprises ports 105, a random number generator 110, and a circuit 115. The circuit could be (but not limited to) a network switch or a router, which forwards the packet to its destination, based on predetermined or dynamically calculated switching/routing paths.

The ports 105 receive packets 120. The ports 105 can be a logical or physical networking port or could be an aggregated set of ports (trunk ports). The random number generator logic 110 generates time varying random numbers. The random numbers vary with time. In certain embodiments of the present invention, the random number generator can comprise, but not limited to, for example, a linear feedback shift register. Alternatively, the random number generators can be implemented as software or firmware executed by a processor.

In one embodiment, all of the random number generators 110 in the network can generate the same random value, so that 100% match will occur, if the packet happens to pass the router/switch at that same time anywhere in the network. Where the random number generator 110 is continuously generating time varying random numbers, as and when the packet arrives, the random number is applied on the incoming packet.

In another embodiment, the random number generator 110 gets triggered only when the packet arrives and then this generator generates a value to be applied to the incoming packet. Furthermore, in certain embodiments, there could be many random number generators 110 running inside a chip and each random number generator 110 can be identified with an identifier inside the chip. Depending on the ingress packet, that is after parsing and classification, it could be allocated a random number generator identifier, so that the particular packet picks the random value from the identified random number generator 110. Other incoming packets can be allocated a different random number generator 110, depending upon their classification. According to certain embodiments of the present invention, this can be accomplished using the fast flexible filter processor based architecture described in “Fast Flexible Filter Processor Based Architecture for a Network Device”, U.S. Pat. No. 6,876,653, by Relan, et. al., issued Apr. 5, 2005, and incorporated herein by reference in its entirety for all purposes.

In another embodiment of the present invention, the random number generators 110 in the network are provided seeds through a secure network, such as the network described in “Integration of Secure Identification Logic into Cell Phone”, U.S. application Ser. No. 10/801,470, Publication No. 2005-0208891, attorney docket number 15469US01, filed Mar. 16, 2004, by Relan et. al., and incorporated herein by reference for all purposes.

The circuit 115 applies the time varying random numbers to the packets 120. The random numbers can be applied to the packets 120 in a variety of ways. For example, the circuit 115 can embed or append the random number into any vacant space within the packet 120. Alternatively, the circuit 115 can add as extra bits/bytes to the packet 120 or alternatively, it could transmit a separate new packet following or trailing packet 120 or it could be just a packet header inserted into the packet. The time varying random number generation can occur at regular intervals. According to certain aspects of the present invention, the regular intervals can be selected to be sufficiently longer than a time representative of the transmission time for a packet from a source to a destination. The random number applied to a packet 120 can be the random number generated by the random number generator 110 at the time that the packet is received. The random numbers generation could be per second, per minute or even per micro-second, depending on the level of security required.

The ports 105 transmit or egress the packet with the random number applied thereto 120′. It is noted that the port 105 that receives or ingresses the packet and the port 105 that transmits the packet can be the same port 105 or different ports 105. Additionally, the ports 105 can both transmit and receive the parameters for the random number generator 110.

In certain embodiments of the present invention, the network node 100 can receive from and transmit over communication channels. The communication channels can be the same or different. For example, the network node 100 can receive the packet 120 from a subscriber access channel that connects the terminal that generated the packet to the network node 100. The network node 100 can also be connected to a backbone of a communication network, such as the Internet. The network node 100 can transmit the packet with the random number applied thereto over the communications network.

In another example, the network node 100 can access the backbone of the communication network via another network node 100 that is entryway to the backbone of the communication network. In the foregoing case, the network node 100 would be referred to as a customer edge router or switch. The network node 100 that is the entryway to the backbone of the communication network would be referred to as the provider edge router or switch.

Referring now to FIG. 2, there is illustrated a flow diagram for transmitting a packet in accordance with an embodiment of the present invention. At 205, the ports 105 receive a packet 120. At 210, the random number generator 110, which is continuously generating time varying random numbers, supplies the current random number. At 215, the circuit 115 applies the random number to the packet 120. At 215, the ports 105 transmit the packet with the random number applied thereto.

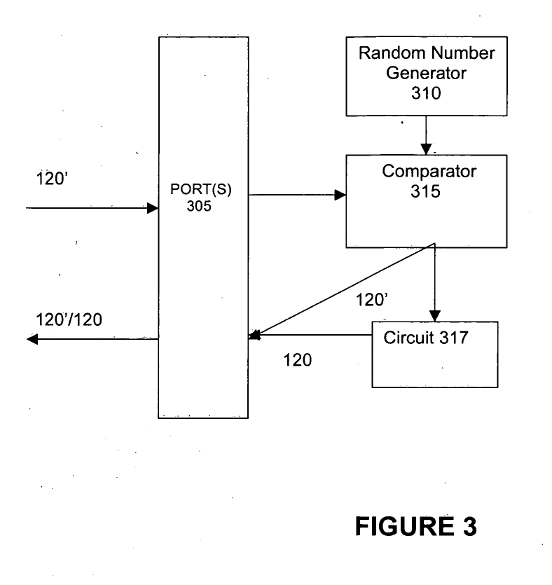

Referring now to FIG. 3, there is illustrated a block diagram describing another exemplary network node 300 in accordance with an embodiment of the present invention. The network node comprises ports 305, random number generator 310, and a comparator 315.

The ports 305 receive packets 120′ that have random numbers applied thereto. The random number generator 310 generates time varying random numbers. In certain embodiments of the present invention, the time varying random numbers can be the same numbers during each time interval with another random number generator at a network node that applied the random number to the packet 120′, such as network node 100.

According to certain aspects of the present invention, the random number generator 310 can comprise a linear feedback shift register. Alternatively, the random number generator 310 can be implemented as software or firmware executed by a processor. Additionally according to certain aspects of the present invention, the ports 305 can transmit and receive seed value or parameters for the random number generator 310 to or from another node, such as node 100.

The comparator 315 compares the random number generated by the random number generator 310 to the random numbers that are applied to the packets 120′. In the case of a match, the ports 305 transmit the packet with the random number applied thereto. According to certain aspects of the present invention, the random number can be removed from the packet by circuit 317, and just the packet 120 is transmitted. It is noted that the ports 305 over which the packets 120′ are received and transmitted, and the port from which the random number generator parameters are received can all be the same, all be different, or comprise a subset that are the same.

Where there are network latencies where packets can arrive with unpredictable delays, a genuine safe packet may not get accepted if it misses the time window of its random number. In certain embodiments of the present invention, the random number generator 310 can maintain a list or table of sequential random values (past, current, future), and compare the random number associated with the incoming packet to any of these values. The length of the list may depend on factors, such as the network latencies.

Alternatively, in one of the embodiments, the random number generator 310 has just one random number that is compared to the random number associated with the packet. Thereafter, circuit 317 removes the previous random value from the packet 120 and applies a new random value, before sending out to the next hop destination. The foregoing provides random value match with immediate neighbors. Depending on the technique used for random number generation, if time-based, the network delays should be within the time window before the next random number generation for accurate match. If the technique is trigger based, then network delays are not an issue.

Alternatively, the random number generator 110 can maintain a list or table of random numbers generated at different times and there can be a time stamp based match by the comparator 315. In the foregoing embodiment, a time stamp could also be transmitted with the packet.

In another embodiment, the random number generator 310 maintains a list/table of random values generated and maps then with, for example, a TTL value of an Ipv4 packet. Depending on the hops jumped, wherein the TTL decrements, the appropriate random value can be selected for matching by the comparator 315.

In certain embodiments of the present invention, the network node 300 can receive from and transmit over communication channels. The communication channels can be the same or different. For example, the network node 300 can receive the packet 120′ from a subscriber access channel that connects the terminal that generated the packet to the network node 300, from the network node 100 that applied the random number to the packet 120, or another network node. The network node 300 can also be connected to a backbone, or part of it, of a communication network, such as the Internet. The network node 300 can transmit the packet with the random number applied thereto over the communications network. Where the network node 300 is the entryway the backbone of the communication network, the network node 300 is referred to as the provider edge router or switch.

In another example, the network node 300 can be the entryway for a destination terminal that the packet 120′ is addressed to. In the foregoing case, the network node 300 is the provider edge router or switch for the destination terminal.

In another example, the network node 300 can be connected to a subscriber access channel that connects the destination terminal. The network node 300 accesses the backbone of the communication network via another network node that is an entryway to the backbone of the communication network for the destination terminal. In the foregoing case, the network node 300 is referred to as a customer edge router or switch. According to certain aspects of the present invention, a customer edge router or switch for the destination terminal can remove the random number from the packet, and just transmit the packet 120.

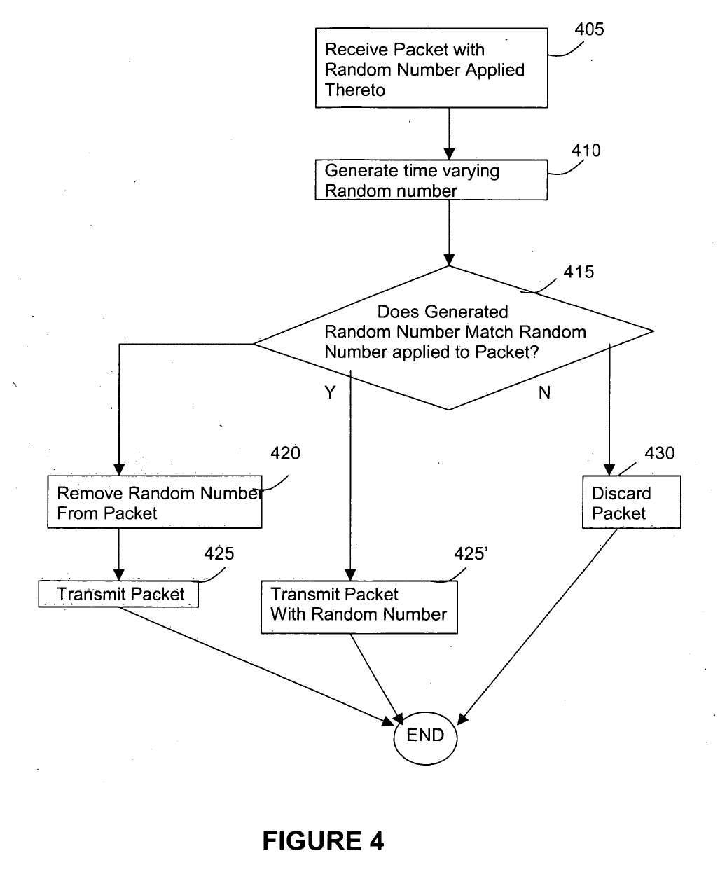

Referring now to FIG. 4, there is illustrated a flow diagram for validating a packet in accordance with one of the embodiments of the present invention. At 405, the ports 305 receive a packet with a random number applied thereto 120′. At 410, the random number generator 310 generates a time varying random number. At 415, the comparator 315 compares the random number from the random number generator 110 to the random number applied to the packet 120′.

If at 415, the random number from the random number generator 310 matches the random number applied to the packet 120′, at 420, the circuit 317 removes the random number applied to the packet 120′ and at 425, the ports 305 transmit the packet 120. Alternatively, in certain embodiments, such as where the network node 300 is the destination customer edge router or switch, if at 415, the random number from the random number generator 310 matches the random number applied to the packet 120′, 420 can be bypassed and at 425′, the ports 305 can transmit the packet with the random number applied thereto 120′. The former is depicted by the path that includes boxes 420 and 425. The latter is depicted by the path that includes box 425′. Alternatively, in certain embodiments, the ports 305 can transmit the packet with a different random number.

If at 415, the random number from the random number generator 310 does not match the random number applied to the packet 120′, the packet 120′ is discarded at 430.

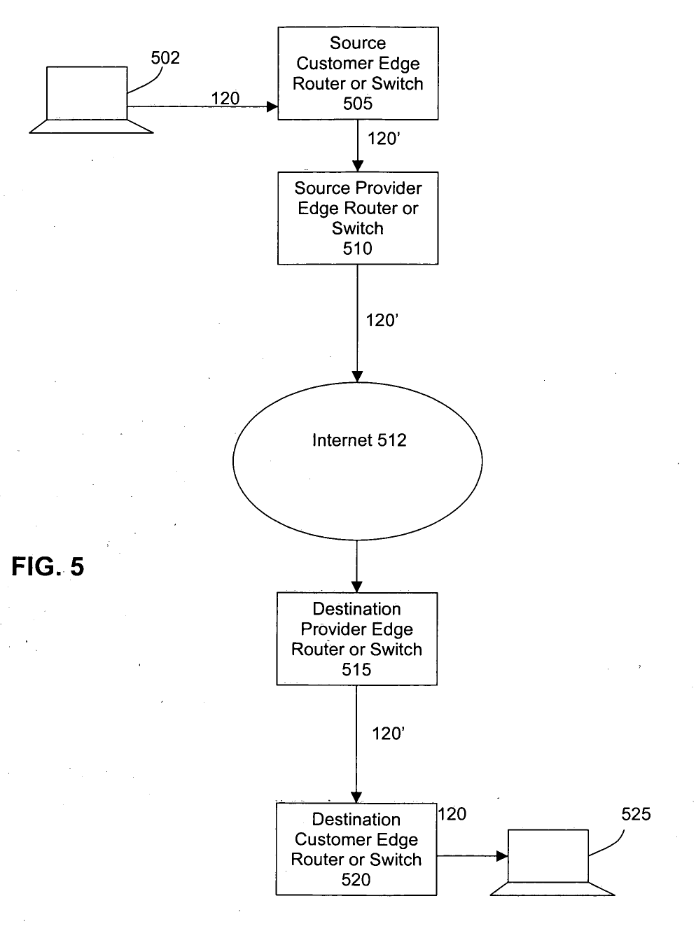

Referring now to FIG. 5, there is illustrated a block diagram of an exemplary communication network 500 in accordance with an embodiment of the present invention. The communication network 500 comprises a source terminal 502, a source customer edge router or switch 505, a source provider edge router or switch 510, a backbone network, such as the Internet 512, a destination provider edge router or switch 515, and a customer edge router or switch 520, and destination terminal 525. The communication network 500 can include a variety of media, such as but not limited to a switched network, including the public switched telephone network, a packet switched network, a fiber optic network, a wireless network, or a cable network

The customer edge router or switch 505 can comprise the network node 100. The source provider edge router or switch 510, and destination provider edge router or switch 515 each comprise network node 300. The customer edge router or switch 520 comprises network node 300, comprising circuit 317.

The source terminal 502 is the terminal that generates the packet 120. The destination terminal 525 is the ultimate destination for the packet 120. The source terminal 502 can generate a client/server connection with the destination terminal 525. During the establishment of the client/server connection, the customer edge routers or switches 505, 520 and provider edge routers or switches 510, 515 can synchronize random number generators 110, 310.

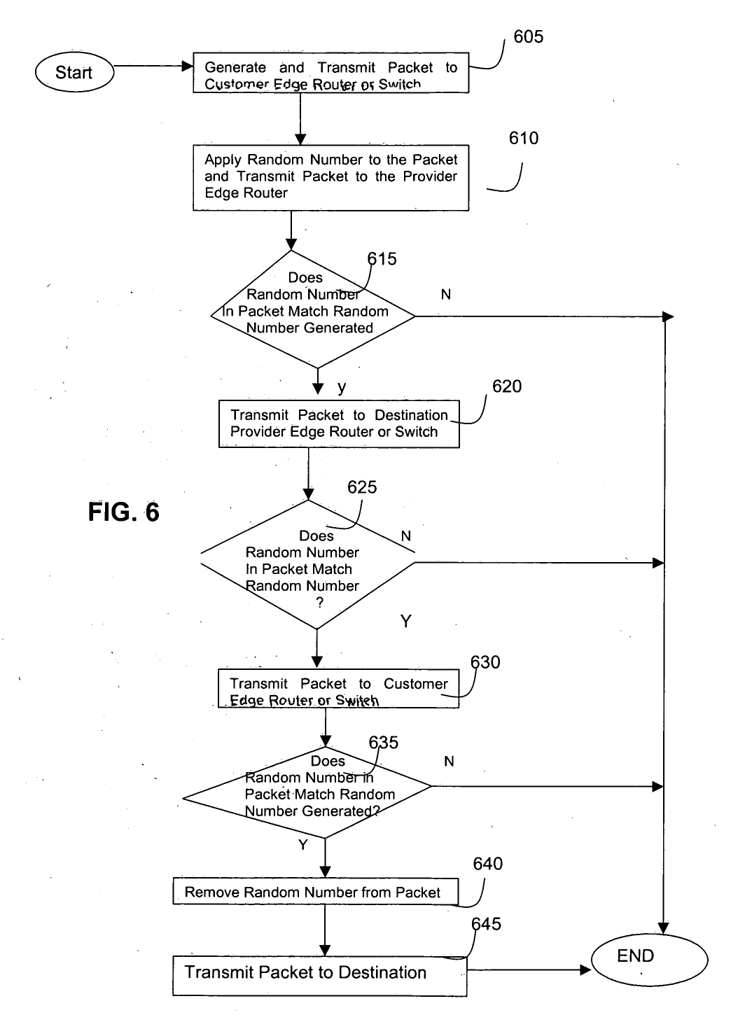

Referring now to FIG. 6, there is illustrated a block diagram describing the routing of a packet in accordance with an embodiment of the present invention. At 605, the source terminal 502 generates the packet and transmits the packet 120 to the customer edge router or switch 505. At 610, the source customer edge router or switch 505 applies a random number to the packet and transmits the packet 120′ to the provider edge router or switch 510. At 615, the provider edge router or switch 510 compares the random number applied to the packet 120′ to a random number generated at the source provider edge router or switch 510. If at 615, the random number matches the random number applied to the packet 120′, the provider edge router or switch 510, the provider edge router or switch 510 transmits (620) the packet with the random number applied thereto 120′, over the backbone network 512 to the destination edge router or switch 515. If at 615, there is not a match, the packet 120′ is discarded.

At 625, the destination provider edge router or switch 515 compares the random number applied to the packet 120′ to a random number generated at the destination provider edge router or switch 515. If at 625, there is a match, the destination provider edge router or switch 515 transmits (at 630) the packet with the random number applied thereto 120′ to the destination customer edge router or switch 520. If at 625, there is not a match, the packet 120′ is discarded.

At 635, the destination customer edge router or switch 520 compares the random number applied to the packet 120′ to a random number generated at the destination customer edge router or switch 520. If at 635, there is a match, the destination customer edge router or switch 520 removes the random number (at 640), and transmits the packet 120 at 645 to the destination terminal 525. If at 635, there is not a match, the packet 120′ is discarded.

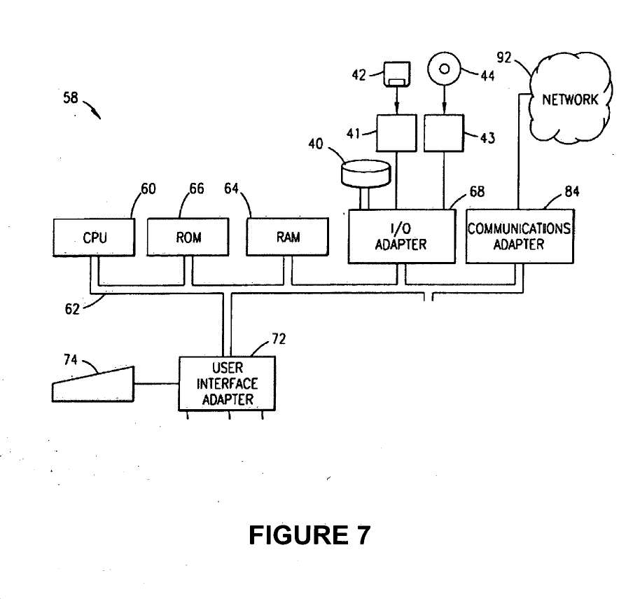

Referring now to FIG. 7, a representative hardware environment for practicing the present invention is depicted. A CPU 60 is interconnected via system bus 62 to random access memory (RAM) 64, read only memory (ROM) 66, an input/output (I/O) adapter 68, a user interface adapter 72, and a communications adapter 84. The input/output (I/O) adapter 68 connects peripheral devices such as hard disc drives 40, floppy disc drives 41 for reading removable floppy discs 42, and optical disc drives 43 for reading removable optical disc 44 (such as a compact disc or a digital versatile disc) to the bus 62. The user interface adapter 72 connects devices such as a LED display 74 to the bus 62. The communications adapter 84 connects the system to a data processing network 92, such as a subscriber access network, or backbone network.

An embodiment of the present invention can be implemented as sets of instructions resident in the random access memory 64 of one or more systems configured generally as described in FIG. 7. Until required by the system, the set of instructions may be stored in another computer readable memory, for example in a hard disc drive 40, or in removable memory such as an optical disc 44 for eventual use in an optical disc drive 43, or a floppy disc 42 for eventual use in a floppy disc drive 41. Those skilled in the art will recognize that the storage of instructions onto a media optically, electrically, magnetically, physically, and/or chemically changes the media.

While the present invention has been described with reference to certain embodiments, it will be understood by those skilled in the art that various changes may be made and equivalents may be substituted without departing from the scope of the present invention.

Additionally, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A network node for transmitting packets, said network node comprising:
at least one port for receiving the packets;
a random number generator for generating random numbers, said random numbers associated and varying with different times; and
a circuit for applying particular ones of the random numbers to the packets; and
wherein the at least one port transmits the packets with the particular ones of the random numbers applied to the packets.

2. The network of claim 1, wherein the random number generator comprises a linear feedback shift register.

3. The system of claim 1, wherein the particular ones of the random numbers applied to the packets are associated with the times that the packets are received.

4. The system of claim 1, wherein the at least one port transmit a signal to another node, said signal providing parameters for the random number generator to the another node.

5. A network node for transmitting packets, said network node comprising:
at least one port for receiving the packets, said packets have particular random numbers applied to the packets;
a random number generator for generating random numbers, said random numbers associated and varying with different times; and
a comparator for comparing particular ones of the random numbers to the particular random numbers applied to the packets;
wherein the at least one port transmits the packets, if comparison of the particular ones of the random numbers and the particular random numbers applied to the packets indicates a match.

6. The network node of claim 5, wherein the ports transmit the particular random numbers applied to the packets with the packets if the comparison indicates a match.

7. The network node of claim 5, further comprising:
a circuit for removing the random number applied to the packets, if the comparison indicates a match.

8. The network node of claim 5, wherein the random number generator comprises a linear feedback shift register.

9. The network node of claim 5, wherein the particular ones of the random numbers compared to the particular random numbers applied to the packets are associated with times that the packets are received.

10. The network node of claim 5, wherein the at least one port receives parameters for the random number generator from another node.

11. A method for transmitting packets, said method comprising:
receiving a packet;
generating random numbers, said random numbers associated with and varying with different times; and
applying a particular one of the random numbers to the packet; and
transmitting the packet with the particular one of the random numbers applied to the packet.

12. The method of claim 11, wherein the particular one of the random numbers applied to the packet is associated with the time that the packet is received.

13. A method for transmitting packets, said network node comprising:
receiving a packet having a random number applied to the packet;
generating random numbers, said random numbers associated with and varying with different times; and
comparing a particular one of the random numbers to the random number applied to the packet;
transmitting the packet, if the particular one of the random numbers matches the random number applied to the packet.

14. The method of claim 13, further comprising:
transmitting the particular random number applied to the packets with the packet if the comparison indicates a match.

15. The method of claim 13, further comprising:
removing the random number applied to the packets, if the comparison indicates a match.
